(19) United States
(12) Patent Application Publication
(10) Pub. No.: US 2012/0018534 A1
(43) Pub. Date: Jan. 26, 2012

(54) SPRAY GUN AND LANCE FOR A PRESSURE WASHER

(75) Inventor: Richard J. Gilpatrick, Whitewater, WI (US)

(73) Assignee: Briggs & Stratton Corporation

(21) Appl. No.: 12/841,049

(22) Filed: Jul. 21, 2010

(51) Int. Cl. B05B 7/26

(52) U.S. Cl. 239/310

(57) ABSTRACT

A lance for a pressure washer spray gun includes an inlet, a first conduit and first outlet, a second conduit and second outlet, and a chemical conduit. The inlet has a first fitting for coupling the lance to a handle of the pressure washer spray gun. The first conduit is coupled to the inlet such that the first conduit is designed to receive water flowing from the inlet. The first outlet is located on an end of the first conduit, and has a second fitting for attachment of a first nozzle body to the first outlet. The second conduit is coupled to the inlet such that the second conduit is also designed to receive the water flowing from the inlet. The second outlet is located on an end of the second conduit, and has a third fitting for attachment of a second nozzle body to the second outlet. The chemical conduit is coupled to the second conduit, and is designed to provide chemicals to the water flowing from the inlet received by the second conduit.

### BACKGROUND

The present disclosure relates generally to the field of pressure washers and high-pressure cleaning machines. More specifically the present disclosure relates to spray guns for pressure washers.

Powered pressure washers are used to clean dirt, paint, or mold from pavement, brick face, cement, or other surfaces. To achieve such results, these devices include a high-pressure water pump and generally provide a high-powered water stream (e.g., approximately 1400 psi) at a modest flow rate (e.g., approximately 1.3 to 1.4 gpm). Heavy duty pressure washers may provide streams with even higher pressures (e.g., 3000 to 5000 psi) at possibly greater flow rates (e.g., approximately 3.5 gpm). The high pressure streams of heavy duty pressure washers facilitate demanding tasks, such as resurfacing or cutting materials.

### SUMMARY

One embodiment of the invention relates to a lance for a pressure washer spray gun. The lance includes an inlet, a first conduit and first outlet, a second conduit and second outlet, and a chemical conduit. The inlet has a first fitting for coupling the lance to a handle of the pressure washer spray gun. The first conduit is coupled to the inlet such that the first conduit is designed to receive water flowing from the inlet. The first outlet is located on an end of the first conduit, and has a second fitting for attachment of a first nozzle body to the first outlet. The second conduit is coupled to the inlet such that the second conduit is also designed to receive the water flowing from the inlet. The second outlet is located on an end of the second conduit, and has a third fitting for attachment of a second nozzle body to the second outlet. The chemical conduit is coupled to the second conduit, and is designed to provide chemicals to the water flowing from the inlet received by the second conduit.

Another embodiment of the invention relates to a pressure washer spray gun that includes a handle, a lance coupled to the handle, an inlet and outlet, a main conduit, a nozzle, and a chemical conduit. The main conduit defines a water flow path extending from the inlet to the outlet, where the main conduit is straight. The nozzle is coupled to the outlet and has an array of parallel conduits. In the nozzle, the main flow path is split and passes through the parallel conduits. The chemical conduit is coupled to the main conduit, and is designed to add chemicals to water of the water flow path. The chemical conduit includes a portion that is substantially parallel with the main conduit.

Yet another embodiment of the invention relates to a spray gun for a pressure washer. The spray gun includes a handle and a lance. The handle has a water flow path through the handle, and includes a trigger. The handle further includes a first fitting for coupling to a high-pressure hose, and a second fitting. The lance includes an inlet, a first conduit and first outlet, a second conduit and second outlet, and a chemical conduit. The inlet has a third fitting for attachment to at least one of the second fitting of the handle and an extension from the handle that is attached to the second fitting. The first conduit is coupled to the inlet such that the first conduit is designed to receive flow from the inlet. The first outlet is located on an end of the first conduit, and has a third fitting for attachment of a first nozzle body to the first outlet. The second conduit is coupled to the inlet such that the second conduit is also configured to receive flow from the inlet. The second outlet is located on an end of the second conduit, and has a fourth fitting for attachment of a second nozzle body to the second outlet. The chemical conduit is coupled to the second conduit of the lance, and provides chemicals to a water stream of the second conduit during operation of the spray gun.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a perspective view of a pressure washer, spray gun, and chemical storage container according to an exemplary embodiment of the invention.

FIG. 2 is a side view of a spray gun for a pressure washer according to an exemplary embodiment of the invention.

FIG. 3 is a side view of a lance for the spray gun of FIG. 2.

FIG. 4 is a perspective view of a portion of the spray gun of FIG. 2.

FIG. 5 is a side view of a lance according to another exemplary embodiment of the invention.

FIG. 6 is a side view of a lance according to yet another exemplary embodiment of the invention.

FIG. 7 is a perspective view of a nozzle for a pressure washer spray gun according to an exemplary embodiment of the invention.

FIG. 8 is a sectional view taken generally along line 8-8 of FIG. 7.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

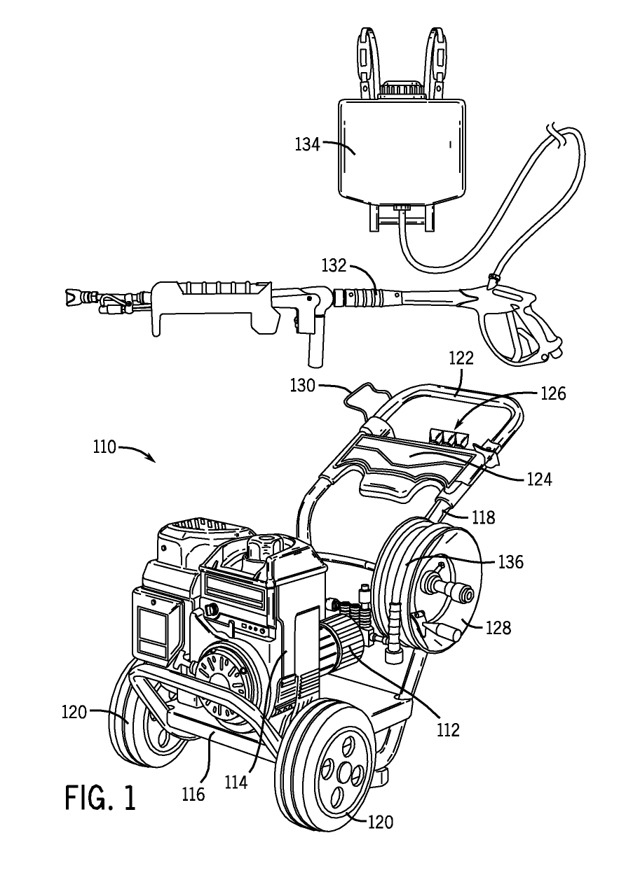

Referring to FIG. 1, a pressure washer 110 includes a high-pressure pump 112 coupled to an internal combustion engine 114. In some embodiments, the pump 112 is a radial or axial cam pump (e.g., triplex pump), while in other contemplated embodiments the pump is another form of positive-displacement pump, or is a centrifugal pump. In some embodiments, the engine 114 is a horizontally-shafted, single-cylinder, gasoline-powered, four-stroke-cycle engine, while in other contemplated embodiments the engine may be vertically-shafted, may have two or more cylinders, may be diesel-powered or substituted with an electric motor, may have a two-stroke cycle, or may be otherwise configured.

According to an exemplary embodiment, the pump 112 and engine 114 of the pressure washer 110 are mounted to a base plate 116 of a mobile frame 118, which further includes wheels 120, a handle 122, a billboard 124 supporting an assortment of different nozzles 126, a hose reel 128, and a holster 130 for a pressure washer spray gun 132. In some embodiments, a chemical storage container 134 may be coupled to the spray gun 132, the water pump 112, or conduits (e.g., high-pressure hose line 136) extending between the water pump 112 and the spray gun 132, or between a source (e.g., outdoor faucet) and the water pump 112. As such, chemicals (e.g., soap, fertilizer, pesticide, dye) may be added to water flowing through or from the pressure washer 110.

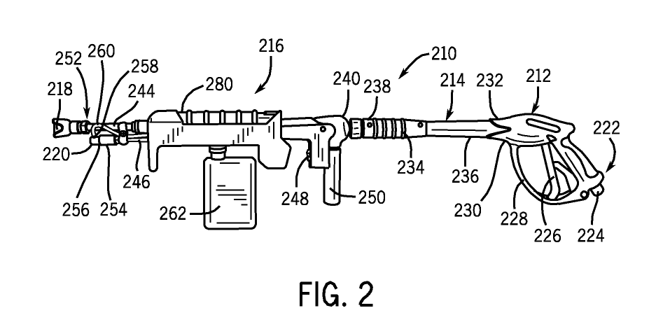

Referring to FIG. 2, a spray gun 210 for a pressure washer (see, e.g., pressure washer 110 as shown in FIG. 1) includes a handle 212, an extension 214 (e.g., handle lance), and a lance 216. When assembled, the lance 216 attaches to the extension 214, which attaches to the handle 212. During operation, the handle 212 is coupled to a high-pressure hose line (see, e.g., high-pressure hose line 136 as shown in FIG. 1), which receives water from a pressure washer pump (see, e.g., pump 112 as shown in FIG. 1). By way of example, the water enters the spray gun 210 through the handle 212, continues through the extension 214 and the lance 216, and exits the spray gun 210 through at least one of two (or more) nozzles, such as a high-pressure nozzle 218 and a chemical-delivery nozzle 220 (e.g., soaper nozzle). In other embodiments, the lance 216 attaches directly to the handle 212 of the spray gun 210.

According to an exemplary embodiment, the handle 212 includes an inlet 222 having a fitting 224 (e.g., coupling, connector) that is designed to attach to a conduit, such as the high-pressure hose line. In some embodiments, the fitting 224 is a male or female quick-connect coupling, a male or female threaded coupling, or another form of hose coupling. The handle 212 further includes a trigger 226 in the form of a biased lever that is movable within a trigger guard 228. In other contemplated embodiments, the trigger may be a rotatable sleeve, a button, or another form of trigger.

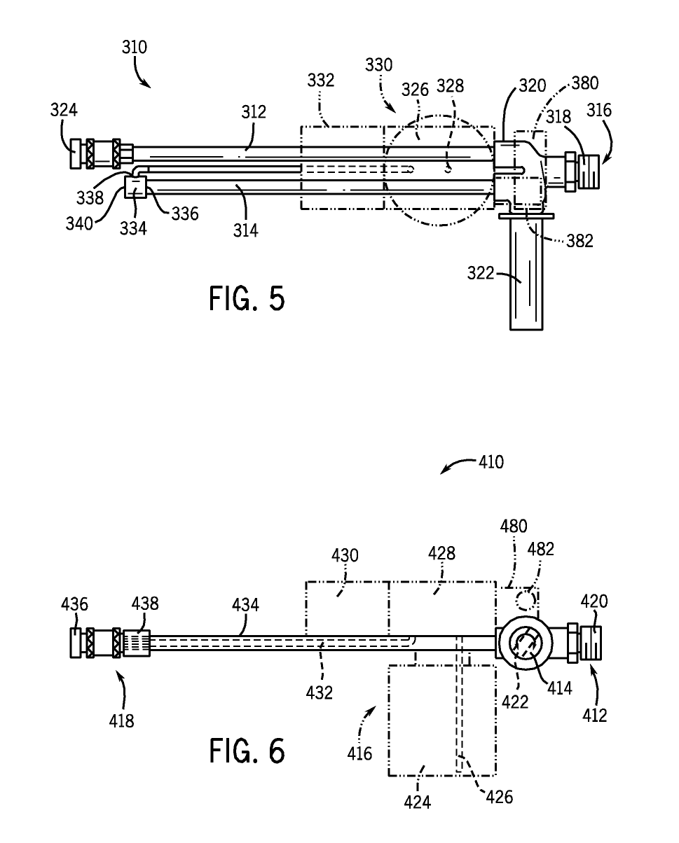

Pulling the trigger 226 operates a flow-control valve (e.g., piston valve, poppet, ball valve, etc.) (see valve 320 as shown in FIG. 5), which selectively opens a flow path through the handle 212. According to an exemplary embodiment, when the flow-control valve is open, the water flows through the handle 212 and to a shaft 230 (e.g., upper housing) of the handle 212, which includes an outlet 232 having a fitting (see, e.g., fitting 224). As with the fitting 224 of the inlet 222, the fitting of the outlet 232 may be a male or female quick-connect coupling, a male or female threaded coupling, or another form of coupling for attachment of the extension 214, the lance 216, or one of the nozzles 218, 220.

Still referring to FIG. 2, in some embodiments the extension 214 is attached to the outlet 232 of the handle 212, and includes a conduit (e.g., passage) that is substantially straight (see, e.g., straight section 434 as shown in FIG. 6). The extension 214 may include a surface 234 for gripping or holding the spray gun 210. On an end 238 of the extension 214 opposite to the end 236 attached to the handle 212 is yet another fitting for attachment of the lance 216.

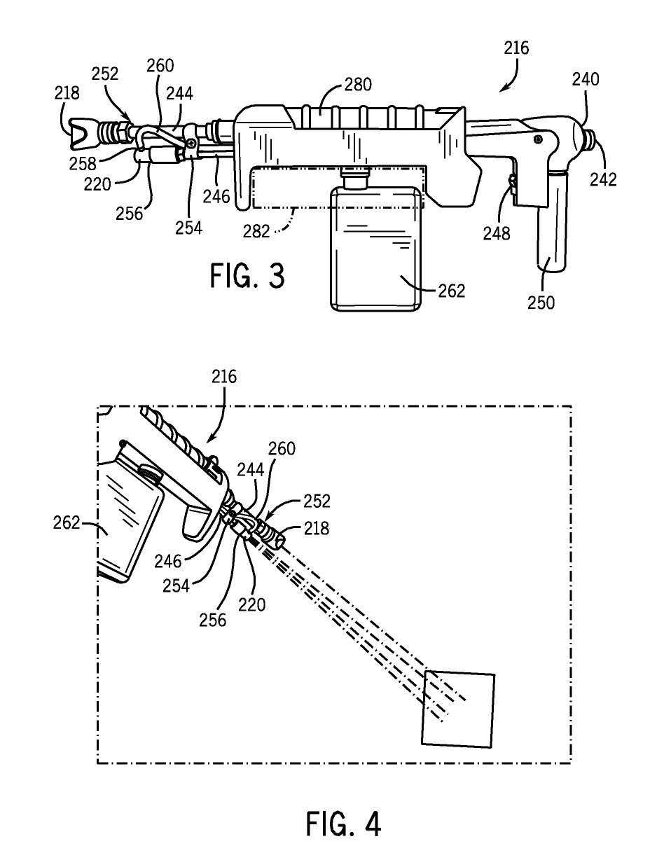

Referring now to FIGS. 2-3, the lance 216 is attached to the extension 214 (FIG. 2), and includes an inlet 240 having a fitting 242 (FIG. 3) and a conduit extending from the inlet 240 and defining a main flow path through the lance 216. According to an exemplary embodiment, the conduit divides into first and second passages 244, 246 (e.g., barrels, conduits) proximate to a directional-control valve (see, e.g., valve 320 as shown in FIG. 5). The passages 244, 246 are selectively coupled to the inlet 240 such that each passage 244, 246 is configured to receive water flowing from the inlet 240.

In some embodiments, the first and second passages 244, 246 are arranged vertically, with the first passage 244 above the second passage 246, or vice versa. In other contemplated embodiments, the passages are arranged horizontally, side-by-side. In still other contemplated embodiments, the passages are co-annular, with the first passage extending through the second passage, or vice versa. In some embodiments, more than two passages extend from the directional control valve and are selectively coupled to the inlet 240 (e.g., one high-pressure flow passage and two separate chemical-delivery passages).

Referring to FIG. 3, an actuator 248 (e.g., trigger, switch, etc.) for the directional-control valve is located proximate to a handle 250 (e.g., forward handle, auxiliary handle) extending from the lance 216. In still other contemplated embodiments, an actuator for the valve is coupled to the handle 212 of the spray gun or to the extension 214. In some embodiments, the directional-control valve may be automatically actuated by way of a change in flow conditions (e.g., pressure, flow rate) detected by one or more sensors coupled to the pressure washer (see, e.g., pressure washer 110 as shown in FIG. 1).

From the directional-control valve, the first and second passages 244, 246 extend in generally straight directions that are substantially parallel with each other and substantially parallel with the direction of the main flow path through the extension 214 and conduit extending from the inlet 240 of the lance 216. Each passage 244, 246 further includes an outlet 252, 254 having a fitting (see, e.g., fitting 224 as shown in FIG. 2) for attachment of the nozzles 218, 220. As such, the lance 216 of FIG. 3 is designed to selectively use either or both of the two nozzles 218, 220, where each nozzle 218, 220 serves a different function.

In some embodiments, the nozzle 218 for the first passage 244 is a commercially-available pressure washer nozzle (e.g., 0-degree, 15-degree, 25-degree, or 40-degree spray beam) having a quick-connect or threaded fitting for attachment to the first passage 244. According to an exemplary embodiment, the first passage 244 and associated nozzle 218 of the lance 216 function as a pressure washer lance designed for high-pressure cleaning, blasting, resurfacing, or other functions. In some embodiments, the water pressures of the first passage 244 and associated nozzle 218 exceed 1000 psi (e.g., about 2000-3000 psi).

In some embodiments, the second passage 246 and associated nozzle 220 of the lance 216 is designed for flushing, flooding, or other functions, which may be performed with a lower-pressure and higher flow rate of water when compared to the high-pressure flow of the first passage 244. According to an exemplary embodiment, the second passage 246 and associated nozzle 220 are designed to operate at pressures that are less than the first passage 244, such as less than half the pressure of the first passage 244. In some such embodiments, the second passage 246 and associated nozzle 220 is designed to function with water pressure of 300-500 psi, during operation of the spray gun 210.

According to an exemplary embodiment, the nozzle 220 for the second passage 246 is a chemical-delivery nozzle (e.g., soaper nozzle), and includes an inlet 256 (e.g., main inlet, water inlet) having a fitting for attachment to the second passage 246. The nozzle 220 further includes a second inlet 258 with a fitting (e.g., push-to-connect fitting or other fitting), for receiving chemicals from a chemical conduit 260. According to an exemplary embodiment, the chemical conduit 260 extends to the nozzle 220 from a pump (see, e.g., pump system 330 as shown in FIG. 5) connected to a chemical storage container 262. The chemical storage container 262 may be attached to the lance 216 proximate to the handle 250 of the lance 216, or may be otherwise coupled to the pressure washer (see, e.g., chemical storage container 134 as shown in FIG. 1).

In some embodiments, the flow of chemicals supplied to the nozzle 220 of the second passage 246 may be controlled by an actuator, such as a trigger or switch. The actuator may be integrated with the actuator 248 associated with the directional-control valve. In some embodiments, the actuator 248 is a trigger that when pulled moves the directional-control valve to close the first passage 244 and open the second passage 246. The degree to which the trigger is pulled controls the flow of chemicals added to the water passing through the second passage 246. In some embodiments, the lance 216 further includes a housing 280 for a chemical pump and batteries. An alternate geometry 282 for a chemical storage container is shown in FIG. 3.

In other contemplated embodiments, a manual plunger pump having a push-button actuator on the back of the handle 250 of the lance 216 allows for control of the amount of chemicals added to the water passing through the second passage 246, while the actuator 248 controls the flow rate of water passing through the second passage 246. In other contemplated embodiments, the chemicals are automatically drawn into the water passing through the second passage 246 by way of a venturi nozzle or other form of pump.

Referring to FIG. 5, a lance 310 for a pressure washer spray gun (see, e.g., spray gun 210 as shown in FIG. 2) includes a first water tube 312 and a second water tube 314, with each water tube 312, 314 connected to a common inlet 316. The inlet 316 includes a fitting 318 for coupling the lance 310 to the spray gun. In some embodiments, the inlet 316 is positioned proximate to a flow-control valve 320 (e.g., spool valve, ball valve) coupled to an actuator 382 (e.g., thumb button) associated with an actuator housing 380 of a handle 322 of the lance 310. In various embodiments, the actuator operates by way of rotation of the handle 322, sliding of the handle 322, twisting of the handle 322, or moving of a trigger (see, e.g., trigger 226 as shown in FIG. 2) associated with the handle 322 to control the valve 320.

In a first configuration, the flow-control valve 320 directs flow to the first water tube 312. In a second configuration, the flow-control valve 320 directs flow to the second water tube 314. In some embodiments, the flow-control valve 320 functions as a two-way switch, allowing flow from the inlet 316 to pass to either the first water tube 312 or the second water tube 314. In other contemplated embodiments, the flow-control valve 320 allows for control of the flow rate to either or both of the water tubes 312, 314, and may also completely shut off flow to the water tubes 312, 314.

According to an exemplary embodiment, the first water tube 312 is designed to receive a high-pressure flow of water (e.g., greater than 1000 psi). In some embodiments, the first water tube 312 is substantially straight, and the high-pressure flow of water passes through the first water tube 312 to a first nozzle 324 attached to the end of the first water tube 312. In some embodiments, the first nozzle 324 may be attached to the first water tube 312 via a threaded or quick-connect coupling. The first nozzle 324 guides the high-pressure flow of water during ejection of the water from the lance 310.

According to an exemplary embodiment, the lance 310 further includes a removable chemical container 326 attached to a side or top of the lance 310 proximate to the handle 322. A chemical tube 328 is coupled to the chemical container 326 and designed to allow chemicals to flow from the chemical container 326, and through the chemical tube 328. In some embodiments, the lance 310 further includes a pump system 330 coupled to at least one of the chemical container 326 and the chemical tube 328. In some such embodiments, the pump system 330 includes a direct-current motor (e.g., battery-powered) that drives a pump (e.g., small positive displacement pump), which in turn drives the chemicals through the chemical tube 328. A power supply 332, such as a rechargeable battery or power cord, is at least partially attached to the lance 310 and selectively coupled to the motor. In other embodiments, the pump is manually powered, such as a pneumatic pump that pressurizes the chemical storage container, pushing the chemicals to the chemical tube.

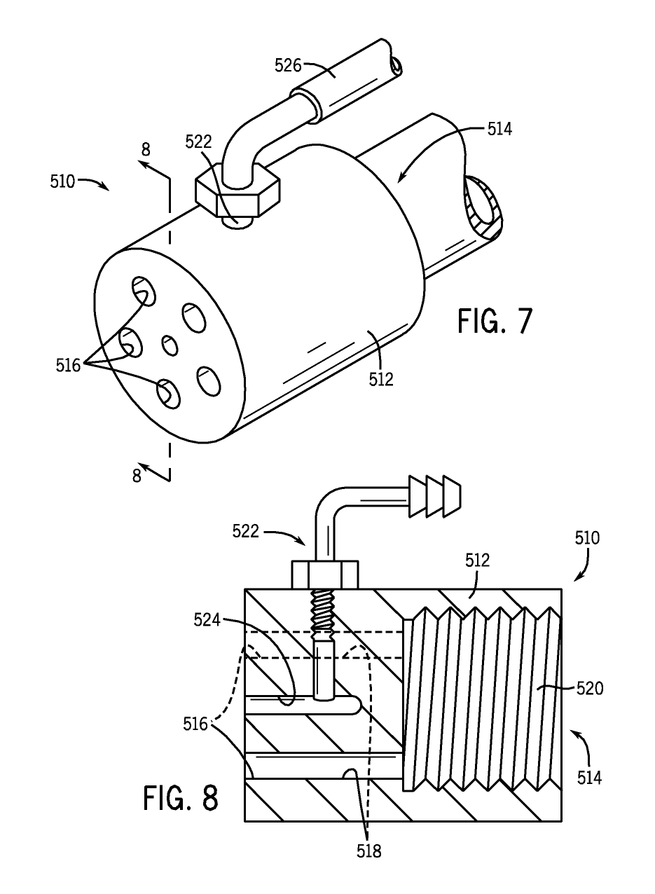

According to an exemplary embodiment, the second water tube 314 is designed to receive a lower-pressure flow of water (e.g., less than 1000 psi), but at a higher flow rate than the first water tube 312. The second water tube 314 is substantially straight, and the flow of water passes through the second water tube 314 to a second nozzle 334 (see also nozzle 510 as shown in FIGS. 7-8), which may be attached to the second water tube 314 via a threaded fitting, a quick-connect coupling, or other fitting. According to an exemplary embodiment, the second nozzle 334 for the second water tube 314 is a chemical-delivery nozzle and includes a water inlet 336, a chemical inlet 338, and an outlet 340 (e.g., plurality of openings) for both water and chemicals. In such an embodiment, the chemical inlet 338 is connected to the chemical tube 328 that delivers the chemicals to the second nozzle 334 from the chemical container 326.

By connecting the inlet 316 of the lance 310 to the pressure washer spray gun, both the first water tube 312 and the second water tube 314 are simultaneously engaged. During operation of the lance 310, the design of the lance 310 allows a user to efficiently switch back and forth between water tubes 312, 314 and associated nozzles 324, 334, flooding a cleaning target with a mixture of water and chemicals and then cleaning the target with a high-pressure spray, which is intended to benefit the cleaning performance of the associated pressure washer.

Referring to FIG. 6, a lance 410 for a pressure washer spray gun includes an inlet 412, a flow control device 414, a chemical-delivery system 416, and a nozzle assembly 418. The inlet 412 includes a fitting 420 for attachment to a handle or extension from the handle of the pressure washer spray gun (see, e.g., handle 212 and extension 214 as shown in FIG. 2). In some embodiments, the flow control device 414 includes a valve designed to selectively allow flow to pass through the lance 410 such as a rotatable ball valve 422. According to at least one embodiment the ball valve 422 of the flow-control device 414 may be rotated relative to the inlet 412 to control the flow rate through the ball valve 422. In the fully-open position the ball valve 422 provides an unobstructed flow path through the ball valve 422.

According to an exemplary embodiment, the chemical-delivery system 416 includes a removable chemical container 424, a chemical suction tube 426, a motor and pump system 428, a power source 430 for the motor and pump system 428, and a chemical-delivery tube 432. The removable container 424 optionally contains chemicals for delivery through the spray from the pressure washer spray gun. The chemical suction tube 426 allows chemicals to be received from the chemical container 424. According to an exemplary embodiment, the motor and pump system 428 provide suction to the chemical suction tube 426, and further drive the chemicals received from the chemical container 424 through the chemical-delivery tube 432. In some embodiments, the lance 410 may be operated without chemicals in the chemical container 424 or without the chemical container 424 attached.

According to an exemplary embodiment, the lance 410 includes a substantially straight section 434 through which the water passes from the inlet 412 to the nozzle assembly 418. In some embodiments, the chemical-delivery tube 432 passes through at least a portion of the substantially straight section 434 of the lance 410. As such, a flow of chemicals and a flow of water move in substantially parallel directions through the lance 410 during operation of the pressure washer. In some embodiments, the chemical-delivery tube attaches to the lance by way of the nozzle assembly (see, e.g., chemical inlet 338 as shown in FIG. 5).

Still referring to FIG. 6, the nozzle assembly 418 includes a high-pressure nozzle 436 that may be attached to the lance 410 via a fitting (see, e.g., fitting 420), such as a threaded or quick-connect coupling. The nozzle assembly 418 further includes a flow-conditioning section 438, which may be fastened to the lance 410 or integrated with the lance 410 (e.g., welded). According to an exemplary embodiment, the flow-conditioning section 438 splits the water flow path into a plurality of substantially parallel channels, and further includes a channel for the chemical-delivery tube. The plurality of channels are intended to remove turbulence from the water, and to facilitate the mixing of the chemicals into the flow of water. By way of example, the channel for the chemical-delivery tube may be positioned between channels for water so that the chemicals are delivered to an internal portion of the water flow, believed to improve mixing of the chemicals and water. One or more screens (e.g., mesh) may also be positioned in the flow path in conjunction with or in place of the plurality of parallel conduits for conditioning the flow by removing turbulence.

Referring now to FIGS. 7-8, a nozzle 510 for a lance (see, e.g., lance 216 as shown in FIG. 3) includes a body 512 having a main inlet 514 with a fitting 520 (e.g., quick connect coupling or threaded fitting) and a plurality of outlets 516. The body 512 may be integrally formed, such as by casting or molding. Between the main inlet 514 and the outlets 516, the flow path through the nozzle 510 is split into a plurality of conduits 518 (FIG. 8) intended to remove turbulence from the flow. In some embodiments, the conduits 518 are substantially parallel to each other. According to an exemplary embodiment, the conduits 518 extend longitudinally through at least a quarter of the body 512, such as about half of the body 512 (e.g., at least a quarter inch long), to control the turbulence of the flow.

According to an exemplary embodiment, the nozzle 510 further includes a chemical inlet 522 designed to be connected to a chemical tube 526 (FIG. 7) coupled to a source of chemicals (see also chemical conduit 260 as shown in FIGS. 2-3). Chemicals pass into the nozzle 510 through the chemical inlet 522 and into one or more conduits 524 associated with the plurality of conduits 518. In some embodiments, at least one of the conduits 524 from the chemical inlet 522 extends between two or more conduits 518 for water, so that the chemicals are delivered to an internal part of the water stream. During operation of the nozzle 510, water and chemicals simultaneously exit the nozzle by way of the outlets 516 from the conduits 518, 524. The conduits 518, 524 are spaced apart and oriented such that the separate streams of water and chemicals combine outside of the nozzle 510 to form a single stream (see generally FIG. 4).

The construction and arrangements of the spray gun and lance for a pressure washer, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A lance for a pressure washer spray gun having a handle, comprising:
an inlet having a first fitting for coupling the lance to the handle;
a first conduit coupled to the inlet such that the first conduit is configured to receive water flowing from the inlet;
a first outlet on an end of the first conduit, the first outlet having a second fitting for attachment of a first nozzle body to the first outlet;
a second conduit coupled to the inlet such that the second conduit is configured to receive the water flowing from the inlet;
a second outlet on an end of the second conduit, the second outlet having a third fitting for attachment of a second nozzle body to the second outlet; and
a chemical conduit coupled to the second conduit, and configured to provide chemicals to the water flowing from the inlet received by the second conduit.

2. The lance of claim 1, wherein the chemical conduit does not provide the chemicals to the water flowing from the inlet received by the first conduit.

3. The lance of claim 2, further comprising:
a first nozzle coupled to the first outlet; and
a second nozzle coupled to the second outlet.

4. The lance of claim 3, wherein the chemical conduit is coupled to the second conduit by way of an opening in the second nozzle.

5. The lance of claim 4, wherein a portion of the chemical conduit has a chemical flow path that extends substantially parallel with a water flow path of the second conduit.

6. The lance of claim 5, wherein the chemical conduit further includes a chemical outlet positioned within the water flow path such that the chemicals are delivered to an internal part of the water flow path.

7. The lance of claim 6, wherein the first nozzle is a high-pressure nozzle designed to receive water pressures exceeding 1000 psi, and wherein the chemical conduit is not coupled to the first conduit.

8. The lance of claim 6, further comprising:
a directional-control valve functionally positioned between the inlet and the first and second conduits, wherein the directional-control valve in a first configuration permits flow from the inlet to the first outlet and blocks flow to the second outlet, and wherein the directional-control valve in a second configuration permits flow from the inlet to the second outlet and blocks flow to the first outlet.

9. A pressure washer spray gun, comprising:
a handle;
a lance coupled to the handle;
an inlet;
an outlet;
a main conduit defining a water flow path extending from the inlet to the outlet, wherein the main conduit is straight;
a nozzle coupled to the outlet and having an array of parallel conduits, wherein the main flow path is split and passes through the parallel conduits;
a chemical conduit coupled to the main conduit, and configured to add chemicals to water of the water flow path, wherein the chemical conduit includes a portion that is substantially parallel with the main conduit.

10. The lance of claim 9, wherein the portion of the chemical conduit is surrounded by the main conduit.

11. The lance of claim 10, wherein the chemical conduit further includes a chemical outlet positioned within the water stream such that the chemicals are delivered to an internal part of the water stream.

12. The lance of claim 11, wherein the nozzle includes an array of apertures through which the water stream exists the nozzle.

13. The lance of claim 12, further comprising:
a second inlet, wherein the chemical conduit is coupled to the main conduit by way of an opening in the second inlet.

14. The lance of claim 13, wherein the chemical outlet is positioned on the nozzle in the center of the array of apertures.

15. The lance of claim 11, wherein the main conduit and the portion of the chemical conduit are co-annular.

16. A spray gun for a pressure washer, comprising:
a handle having a water flow path through the handle and comprising a trigger, a first fitting for coupling to a high-pressure hose, and a second fitting;
a lance, comprising:
an inlet having a third fitting for attachment to at least one of the second fitting of the handle and an extension from the handle that is attached to the second fitting;
a first conduit coupled to the inlet such that the first conduit is configured to receive flow from the inlet;
a first outlet on an end of the first conduit, the first outlet having a third fitting for attachment of a first nozzle body to the first outlet;
a second conduit coupled to the inlet such that the second conduit is configured to receive flow from the inlet;
a second outlet on an end of the second conduit, the second outlet having a fourth fitting for attachment of a second nozzle body to the second outlet; and
a chemical conduit coupled to the second conduit of the lance, wherein the chemical conduit provides chemicals to a water stream of the second conduit during operation of the spray gun.

17. The spray gun of claim 16, further comprising:
a first nozzle coupled to the first outlet; and
a second nozzle coupled to the second outlet, during operation of the spray gun.

18. The spray gun of claim 17, wherein the chemical conduit is coupled to the main conduit by way of an opening in a second nozzle.

19. The spray gun of claim 18, further comprising:
a directional-control valve functionally positioned between the inlet and the first and second conduits, wherein the directional-control valve in a first configuration permits flow from the inlet to the first outlet and blocks flow to the second outlet, and wherein the directional-control valve in a second configuration permits flow from the inlet to the second outlet and blocks flow to the first outlet.

20. The spray gun of claim 19, further comprising:
a chemical storage container attached to the spray gun during operation of the spray gun, and
a pump coupled to the chemical storage container for delivering chemicals from the chemical storage container to the chemical conduit.
